(19) United States
(12) Patent Application Publication
(10) Pub. No.: US 2017/0213289 A1
(43) Pub. Date: Jul. 27, 2017

(54) Dividend Yielding Digital Currency through Elastic Securitization, High Frequency Cross Exchange Trading, and Smart Contracts

(71) Applicant: George Daniel Doney, Riva, MD (US)

(72) Inventor: George Daniel Doney, Riva, MD (US)

(21) Appl. No.: 15/416,202

(22) Filed: Jan. 26, 2017

Related U.S. Application Data
(60) Provisional application No. 62/388,333, filed on Jan. 27, 2016.

(51) Int. Cl. G06Q 40/06; G06Q 40/02

(52) U.S. Cl. CPC G06Q 40/06; G06Q 40/025

(57) ABSTRACT

An apparatus, computer-readable medium, and computer-implemented method for creating collateralized portfolios. A portfolio is a collection of income-producing assets. These income-producing assets are a derivative of primary sources such as real property. A portfolio is generated through transactions that exchange estimated asset value for liquid instruments in the portfolio. Asset valuation is determined through known pricing functions. Transaction elasticity is provided by liquid instruments (reserve funds and portfolio-owned shares) held in reserve in the portfolio's reservoir which provides a market smoothing function to gracefully adapt to changes in asset demand and risk. Each portfolio's reservoir is collectively owned by the shareholders; continuously replenishing itself with income generated by assets in the portfolio. Shares can be represented by digital tokens, traded as digital currency such as cryptocurrency, and monetized with the convenience of cash through a network of exchanges and payment gateways.

### RELATED APPLICATION DATA

This application claims priority to U.S. Provisional Application Ser. No. 62/388,333 filed on Jan. 27, 2016, the disclosure of which is incorporated herein by reference.

### BACKGROUND

Liquidity, the ability to efficiently convert asset value to cash on demand, is a key characteristic of high performing markets and is the lifeblood of finance. Liquid markets attract capital as investors know that they can efficiently move resources to maximize return and manage risk. The absence of liquidity leaves market opportunities undeveloped. Many investment opportunities, such as emerging technologies or real estate projects in the developing markets, offer significant earning potential but suffer from a lack of liquidity. Despite the potential for return, earning potential for these asset classes may remain dormant. Asset liquidity may be limited to due to lack of information, individual asset risk, uncertain market conditions, large transaction sizes, and irregular or infrequent payouts. Bringing liquidity to these markets will unlock trillions of dollars in latent value and address key issues that affect development and prosperity worldwide.

The practice of securitization, i.e, distributing risk tied to individual assets though portfolios with more predictable systemic risk, has been widely used to unlock liquidity in asset classes. This practice centers on assessing asset risk adjusted net present value, and swapping asset earning potential into a portfolio for cash or shares of like value. This process mitigates individual asset risk providing more predictable investment opportunity. Without securitization, the investor in an asset bears the full burden (or benefit) of anomalous performance of individual assets. With securitization, asset performance is distributed across the entire portfolio minimizing the impact to investors of risks and unforeseen events that affect individual assets. Securitized portfolios produce a more predictable return as risk is isolated to portfolio manager performance and systemic class-wide factors that can be hedged. The investor benefits from broad potential in an asset class without direct knowledge risks and performance of each asset.

One example of securitization is a Mortgage-Backed Security (MBS), also known as a “mortgage-related security” or a “mortgage pass through,” which are portfolios based on a collection of mortgages. Effective securitization, i.e. secured assets that behave somewhat predictably based on market conditions, requires large volumes of similar assets that are well known risk characteristics. For example, MBS relies on established statistical models of mortgage payments to compensate for risks such as prepayment risk. Such models typically are developed through years of observation of underlying asset performance.

An MBS can be bought and sold through a broker and has inherent credit and default risk. An investment in a mortgage-backed security brings liquidity to the marketplace providing access to capital to provide loans for home buyers or businesses. An MBS provides a means for a smaller regional banks to provide additional capital to customers through loans. In this scenario, the bank acts as a middleman between the home buyer and the investment markets.

There are two common types of MBSs: pass-throughs and collateralized mortgage obligations, also known as CMOs. Pass-throughs are structured as a trust in which mortgage payments are collected and passed through to investors. Collateralized mortgage obligations are pools of securities, known as “tranches” with various credit ratings which determine the rate of return for investors.

A Real Estate Investment Trust (REIT) is a type of security that invests in real estate property or mortgages, effectively a mutual fund of real estate assets. Investors can buy shares in a REIT to acquire fractional ownership of revenues generated by real estate ventures. REITS are highly regulated with respect to the number of investors, the amount each investor can own, dividend payout ratios, and the types of investments permitted.

Securitization is a central component of the financial infrastructure with well over $10 T dollars of value in securitized portfolios. Despite the benefits, a number of shortcomings in securitization haven given rise to calls for reform. Traditional securitization models lack transparency, are too rigid to address emerging and uncertain markets, lead to “too big to fail” investment practices, are inaccessible to most investors, do not provide efficient pricing models to assess balance sheet impact, and adapt poorly to changes in systemic asset risk. In late 2007 and 2008, MBS were a significant factor in what has become known as the “subprime mortgage crisis.” In this case, limitations of securitization very nearly caused a worldwide financial collapse. The impacts of this crisis have affected the real estate market even to this day. Many argue that shortcomings to securitization have not been addressed and may even be amplified.

Technological innovation in securitization is required to address the conditions that led to the 2008 Global Financial Crisis. These changes include increased transparency, improvements in risk scoring through advanced data science techniques, flexibility to reach “frontier markets” to bring liquidity to the developing world, broader access to investors of all levels, and enhanced liquidity to gracefully adapt to changes in market conditions.

### BRIEF DESCRIPTION OF THE DRAWINGS

FIG. 1 is a schematic illustration of exchange of assets and rights according to an embodiment;

FIG. 2 is a block diagram of a market architecture according to an embodiment;

FIG. 3 is a schematic diagram of a securitized portfolio according to an embodiment;

FIG. 4 is a flowchart of the elastic securitization process according to an embodiment.

FIG. 5 is a schematic illustration of the securitization model and data structure;

FIG. 6 is a graph illustrating a pricing function of the liquidity engine;

FIG. 7 is a schematic diagram of a conventional payment gateway;

FIG. 8A is a schematic diagram of a chained payment gateway; and

FIG. 8B is a flowchart of a chained gateway payment process.

### DETAILED DESCRIPTION

While methods, apparatuses, and computer-readable media are described herein by way of examples and embodiments, those skilled in the art recognize that the invention is not limited to the examples, embodiments or drawings described. Rather, the intention is to cover all modifications, equivalents and alternatives falling within the spirit and scope of the appended claims. Any headings used herein are for organizational purposes only and are not meant to limit the scope of the description or the claims. As used herein, the word “may” is used in a permissive sense (i.e., meaning having the potential to) rather than the mandatory sense (i.e., meaning must). Similarly, the words “include,” “including,” and “includes” mean including, but not limited to.

The disclosed embodiments include a computer architecture and platform for providing a repeatable framework which transforms irregular, illiquid, earning potential into readily exchangeable, digital instruments that can be monetized on demand. Additionally, the disclosed embodiments include a liquidity engine methodology and hardware, a central part of the platform, that ensures the instruments can be efficiently monetized even in the face of rapid changes in market conditions. The disclosed embodiments also include a financial instrument, and corresponding data structure, that combines the liquidity of a currency, the risk diversification of securities, and the price stability of bonds. The instrument is a digital currency that is convenient for commerce, risk diversified, highly liquid, dividend yielding and transferrable.

Applicant has discovered methods, apparatuses, and computer-readable media for—creating a layered pool of assets that behaves in an elastic manner to create market stability, and mitigate anomalous user behavior. The embodiments transform the value of an irregular, illiquid asset into a readily-exchangeable digital currency through a novel securitization process as described below. The asset backed digital instrument represents risk mitigated earning potential, yields a dividend, can be traded in multiple markets, and may be monetized on demand. The flexibility of this instrument brings liquidity to underserved markets uncovering new high yield opportunities for investors. through an instrument combining the convenience of cash with risk diversification of securitization by securing an underlying asset portfolio through the novel process described below.

The applicant provides a repeatable process to transform illiquid earning potential from a range of asset classes including: usage rights, physical and virtual assets, income streams, and talent into readily exchangeable shares of a securitized portfolio. Liquidity is enhanced through 6 repeatable steps: decouple asset ownership from earning potential through contract; mitigate individual asset risk through bundling and systemic risk through hedging; streamline portfolio share listing via exchange on a distributed ledger; publish an immutable record of portfolio asset performance and cash flows for transparency and regulatory compliance via a programmatic interface; provision immediate exchangeability through a liquidity engine; and provide transaction convenience to enable deposit, withdrawals, and payments through chained payment gateways.

Portfolios are collections of earning potential derived from primary income producing assets such as real property. A portfolio is generated through transactions that swap estimated earning potential for liquid instruments in the portfolio. The Net Present Value (NPV) of projected income streams is determined through known pricing functions. Risk adjustments to asset NPV require portfolio specific calculations, data mining, and asset domain knowledge. The repeatable, low barrier to entry portfolio development process offered by the platform permits innovation in this critical function, enabling domain experts and data scientists (not just financiers) to compete for maximum yield though accurate risk assessment.

Shares of asset portfolios are readily traded on an exchange in a manner similar to an Exchange Traded Fund (ETF). By trading shares, investors may adjust holdings or monetize interests in the portfolio on demand. However, for smaller portfolios, large investor movements, or rapidly changing market conditions, may require liquidity than natural market conditions may supply. During these times, investors must pay a significant premium as they attempt to monetize and may experience complete illiquidity, ie no mechanism to monetize value at any price. The applicant has discovered a method to counteract these market discontinuities through a liquidity engine. This engine gives investors significant trading depth even against small portfolios. As a result, new “experimental” portfolios unlocking earning potential in emerging asset classes can be birthed and grow according to the ability to produce yield. This contrasts with traditional securitization models that only get sufficient liquidity through large size limiting applicability to established asset classes and undermining accessibility and innovation in risk pricing and portfolio development

The liquidity engine provides synthetic liquidity through a high frequency market making algorithm that draws on a portfolio owned reservoir of immediately liquid assets. Portfolio (shareholder) owned reserve funds boost market liquidity in a model analogous to the service the Federal Reserve provides to banks. The fundamental difference in the applicant's platform is that the price of liquidity is a market function set by a shaped liquidity curve determined in real time rather than a static rate set by the Federal Reserve board on a periodic basis. The algorithms manage the marginal cost of liquidity discouraging irrational market behavior while maximizing share liquidity. The engine provides a buffer against anomalous market moves and enables a graceful response to precipitous changes in market conditions, Each portfolio's reservoir is collectively owned by the shareholders and continuously replenishes itself with income generated by assets in the portfolio. This function is novel in that the shareholders are liquidity providers and the direct beneficiary liquidity functions rather than third party market makers. That shareholders who do not sell into a market exodus benefit increasingly as the demand for liquidity increases acts as a countercyclical force against the peaks and valleys of the business cycle that undermine traditionally illiquid markets such a real estate.

Income from portfolio assets provides the basis for a dividend distributed to shareholders. As liquidity thresholds are met, additional proceeds are passed to investors as dividends. A reliable portfolio dividend introduces natural price stability to portfolio shares since price reductions caused by a run result in a higher yield attracting investment to counter price change.

The portfolio manager sets income and growth objectives for the portfolio subject to shareholder agreement. These objectives affect the distribution of income to shareholders versus reinvestment for portfolio growth. Asset income is first passed through the reservoir to ensure liquidity requirements are met by replenishing the pool of liquid assets. Once liquidity requirements are met and depending on the growth structure of the portfolio, asset revenue may be added to the portfolio to provide cash to bring additional assets into the portfolio enabling “elastic” growth of portfolio size. Remaining income is distributed to shareholders as a dividend in the form of fiat currency or share distributions depending on asset ratios in the reservoir. The disclosed architecture leverages all available exchanges through a common programmatic interface. This interface simplifies integration with new exchanges and opens doors to new markets. Providing single interface access to all compliant exchanges deepens market depth, broadens available trading options, and maximizes the value returned by an asset conversion.

Through the use of distributed ledger technologies such as blockchain and a network of payment gateways, shares of a portfolio take on the characteristics of a digital currency. This digital currency can be efficiently and securely transferred between shareholders, monetized via payment gateways with the convenience of cash, or exchanged for other asset classes. The disclosed architecture also supports the chaining of payment gateways to provide the convenience of cash to currency holders by simplifying micropayments and leveraging any compliant Point of Sale infrastructure available. This provides a payment system that can quickly transmit value to support nearly any transaction worldwide translating this value to native payment currencies and mechanisms with efficiency.

The disclosed platform applies distributed ledgers to enable investors to have complete transparency into the makeup of the portfolio and inspect all asset cash flows to support informed investment decisions. The use of blockchain or other distributed ledger technologies to record portfolio transactions provides an immutable record of cash flows. This provides investors a high assurance record used to assess the viability of a portfolio and provides regulators oversight and fraud prevention tools. The applicant proposes the use of distributed ledgers with at least some network nodes held by regulators to provide an unalterable record of portfolio transactions.

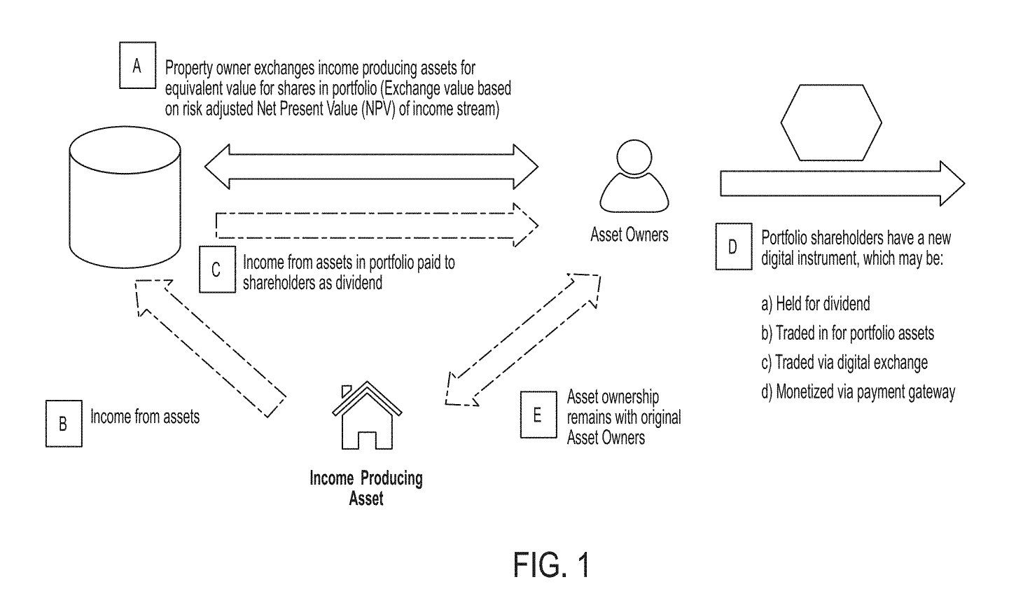

The disclosed embodiments create a repeatable process to unlock latent value in irregular, illiquid assets. This minimizes risk to asset owners as they seek to monetize earning potential by leveraging the benefits of dividend yielding digital currency. As illustrated in FIG. 1, an asset owner exchanges rights to earning potential for equivalent share value of a portfolio or like assets based on, for example, the Risk Adjusted Net Present Value (RANPV) of the related income stream(s) (A). The income from the revenue stream then flows into the portfolio reservoir (B). After meeting portfolio liquidity requirements, this income is paid to shareholders based on their proportional shares (C). Of course, the system may contain more than one asset owner and more than one asset for each owner. Also, shareholders need not be asset owners and can enter the system through the purchase of shares with fiat currency. The result is that the shareholders each have a new instrument, represented by a digital token for example, that is dividend producing, can be traded in for portfolio assets, can be traded via an exchange, and can be easily monetized (D). Of course, the ownership of the asset(s) can remain with the original owner (E).

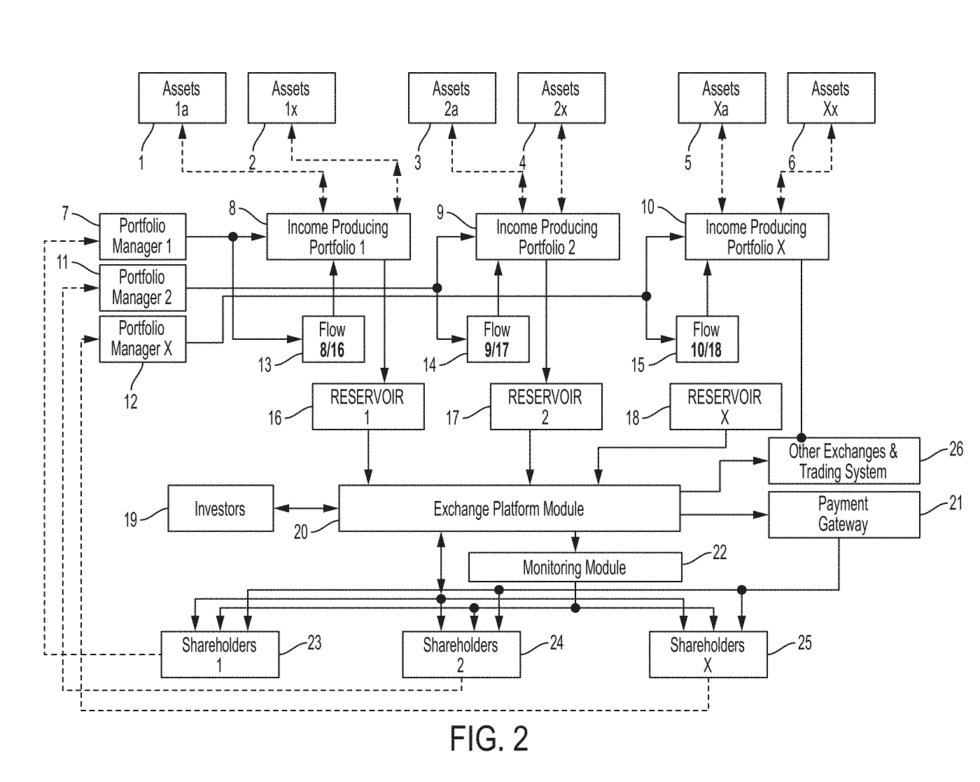

As illustrated in FIG. 2, the architecture manages a repeatable process to establish portfolios of income producing assets 8, 9, and 10 and issue highly exchangeable shares of interest in these portfolios. The shares are represented by a digital token, known as digital currency. “Digital currency” is a network based digital token, or “coin,” representing a unit of value that is tracked by a ledger. Digital currencies that use cryptographic techniques and Distributed Ledger Technology (DLT) to verify transactions, authenticate parties, and track ownership of the tokens are known as cryptocurrencies. Examples of digital currency are Bitcoin and Ethereum Ether™. A digital token can be linked to shares of a portfolio or other assets on a one-to-one basis or in any manner. For example, each token can represent 10 shares. While the embodiment disclosed below uses cryptocurrency tokens, any type of digital token can be linked to share interests.

The embodiments leverage distributed ledger technology (DLT) such as a blockchain. In a distributed ledger, transactions are recorded as “blocks” of data stored in a linear chain. Each block in the chain contains data and is cryptographically hashed. The blocks of hashed data draw upon the previous-block in the chain, ensuring all data in the overall “blockchain” has not been tampered with and remains unchanged. The chain is stored on multiple devices in a peer-to-peer network. The data stored in blocks can be automatically executable code known as a “smart contract.” Smart contracts are computer protocols that facilitate, verify, or enforce the performance of an agreement. The disclosed embodiment leverages smart contracts to ensure proper collateralization of assets on platform and to provide transparency in trading algorithms among other purposes.

Some of the elements of FIG. 2 are referred to as “modules” herein. As used herein the term “module” refers to a functional element including a computer processor executing software instructions that are stored on non-transient computer readable media. The modules are aggregated herein by logical function for the sake of description. However, the various functions can be accomplished by any number of processors executing code and the code and processors can be distributed in any manner. For example, each module can represent a distinct device communicating with other modules over a network, such as the internet. Alternatively, various modules can be embodied in a single device. All data is stored in data structures, such as a database or a blockchain, and can be transmitted using known protocols.

Portfolios of income producing assets 8, 9, 10 are a collection of assets derived from primary like source categories, such as real property assets 1, 2, 3, 4, 5, and 6. Like assets, 1 and 2 for example, are pooled together by Portfolio Managers 7, 11, and 12 to form risk balanced portfolios 8, 9, and 10 of assets with investment grade characteristics. For example, the assets can be rental incomes of small landlords. However, any type of income producing asset, such as mortgages, various loans, bonds, future income, and the like could be used in connection with the invention.

Portfolio Managers 7, 11, and 12 use securitization to bundle income streams into a portfolio. This process may involve the decoupling the earning potential of an illiquid, irregular asset, assessing its risk adjusted net present value of the earning potential, binding all parties through smart contracts, and adding to a portfolio to distribute/mitigate risk, to incorporate new income producing assets 1, 2,3,4, 5, and 6 into respective income producing portfolios 8, 9, and 10. Portfolio managers 7, 11, and 12 can use known techniques such as domain knowledge, and data mining to assign valuation to assets for incorporation into a portfolio 8, 9, and 10. Of course, the identity of all assets in a portfolio can be stored on computer readable media as a data structure, such as a database of records. Resources required to incorporate new assets 1, 2, 3, 4, 5, and 6 into an existing portfolio are drawn from the self-refilling reservoir modules 16, 17, and 18 of liquid assets as described below. This mechanism provides elasticity to the portfolio for growth without dilution.

Each income producing portfolio 8, 9, and 10 is collectively owned by shareholders 23, 24, and 25 feeds a corresponding portfolio reservoir module 16, 17, and 18, respectively. As an example, each reservoir module can be a smart contract executing in a blockchain environment, such as Ethereum. Each reservoir module has predetermined computer executed logic associated therewith to automatically balance the reservoir in the manner described below.

Liquidity in each reservoir module 16, 17, and 18 is replenished by income generated from assets in the corresponding portfolio 8, 9, and 10. As predetermined portfolio controlled liquidity limits are met, additional income is issued to shareholders 23, 24, and 25 as a dividend. The price of liquidity is determined algorithmically from a reservoir module 16, 17, or 18 with characteristics controlled by the respective portfolio manager 7, 11, and 12 and influenced by the shareholders 23, 24, 25 through a market making control function using high frequency trading to provide flow control modules 13, 14, and 15 ensuring sufficient liquidity under changes to market conditions.

As noted above, shares in the incoming producing portfolio 8, 9, and 10 are issued in the form of digital currency. This digital currency can be securely transferred between shareholders 23, 24, and 25, monetized via the payment gateway module 21, or exchanged for other classes of assets via the exchange platform module 20. Other asset classes include currencies, usage rights and other assets accessible through internal and external market systems 26. For example, market system 26 could be a digital currency exchange such as Coinbase™.

Investors 19 may buy or sell the digital currency via the exchange platform module 20 providing liquidity to the system in exchange for access to assets in the portfolios 8, 9, and 10. Monitoring module 22 provides transparency to shareholders 23, 24, and 25 and regulators. Such monitoring can be accomplished through known distributed ledgers, such as blockchain. For example, the monitoring module 22 could be a full node, or a Simplified Payment Verification (SPV) node, on a blockchain or other type of distributed ledger that records transactions in the system. In the case of the monitoring module being a full node, all transactions in the system would be stored by the monitoring module 22. In the case of the monitoring module 22 being an SPV node, only block headers are stored by the monitoring module 22. However, the monitoring module 22 could verify any transactions by querying peer nodes as needed in a known manner.

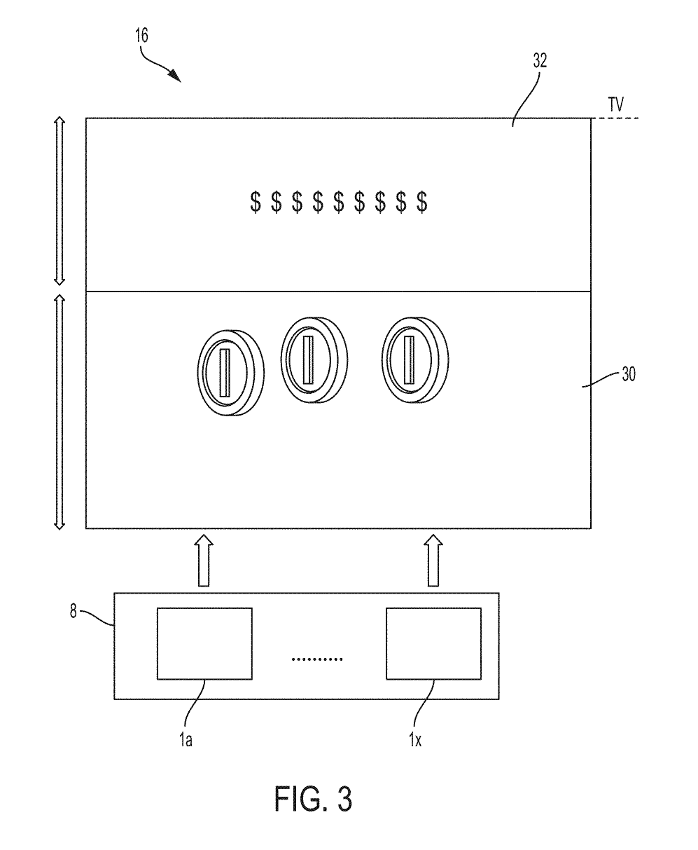

As illustrated in FIG. 3, reservoir module 16 stores and manipulates the grouped rights in underlying assets of portfolio 8. Other reservoir modules operate in a similar manner. Reservoir module 16 uses liquid shares and currency to place limit orders to provide a minimum liquidity for the portfolio. Liquidity engine algorithms seek to balance available assets seeking a desired ratio between the value of liquid assets (typically fiat currency) 32 and reservoir shares 30. The cash reserves are used to pay dividends and to make the market to supplement market demand for share redemption. When reservoir orders are taken, the cash reserves in reservoir module 16 go down. Market making functions drive up the cost of liquidity (integral of available share price) protecting the remaining liquidity offered by the reservoir.

In markets, the spread, i.e. the amount by which the ask price exceeds the bid price for an asset in the market, increases greatly in the wake of a large transaction. Large spreads result in market friction penalizing individuals who use the currency for frequent transactions. The reservoir modules execute an algorithm to augment the order book and manage spread. The algorithm lays in bids and asks using the reservoir to provide certain liquidity characteristics depending on market behavior reservoir balance. The algorithm operates with no information advantage, using only data available to the public. In accordance with the algorithm, changes in the market demand for liquidity are detected based on the cash in the reservoir. The algorithm can be a function executed as a publicly verifiable smart contract in the form of:

f[(trading activity)(asset performance)(reservoir size)(reservoir balance)(portfolio settings)]

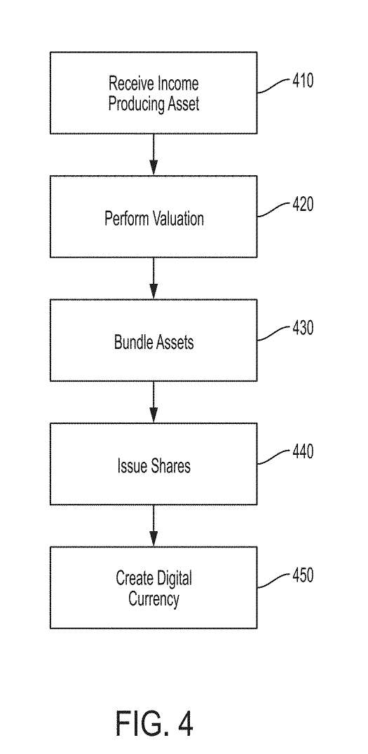

FIG. 4 illustrates the repeatable securitization process. At step 410 rights to an incoming asset are received. For example, through a contract, earning potential can be separated from the underlying asset allowing transfer without change in ownership of the underlying asset. Various owners of income producing assets can grant various rights to the portfolio. For example, the owner of an apartment building could grant full or partial rights in one or more of the rental income steams form tenants. Each granted right is considered as an asset. In step 420, the Risk Adjusted Net Present Value (RANPV) is assessed and a swap or purchase is made by the Portfolio Manager into the portfolio. In step 430 various assets are bundled into a single portfolio or multiple portfolios. Bundling can be accomplished in various known ways to achieve various results, such as levels of risk, levels of income, hedging, and the like.

Once a portfolio of bundled assets has been created, an identity of the bundled assets is stored in a data structure in correspondence to the valuations of those assets. The portfolio is then divided into a predetermined number of shares in step 440, which shares can be granted to parties in exchange for adequate consideration, such as a cash payment. The reservoir is then created with liquid assets and share values in the manner described above. In step 450, a digital token is created for each share. The tokens can be tracked on a distributed ledger and traded as a digital currency. The reservoir is created with liquid assets and share values in the manner described herein.

As noted above, shares in a portfolio can be represented by digital tokens that can be traded as digital currency. For example, transactions of the digital currency can be authenticated and recorded using Distributed Ledger Technology (DLT). As noted above, in such a system, transactions are recorded on ledgers in various peer to peer devices. The transactions are recoded as blocks that are verified through a consensus mechanism, such as a “proof or work” mechanism that requires parties to solve a resource intensive cryptographic hashing process in exchange for remuneration in cryptographic currency. Examples of such systems include the Bitcoin Blockchain.

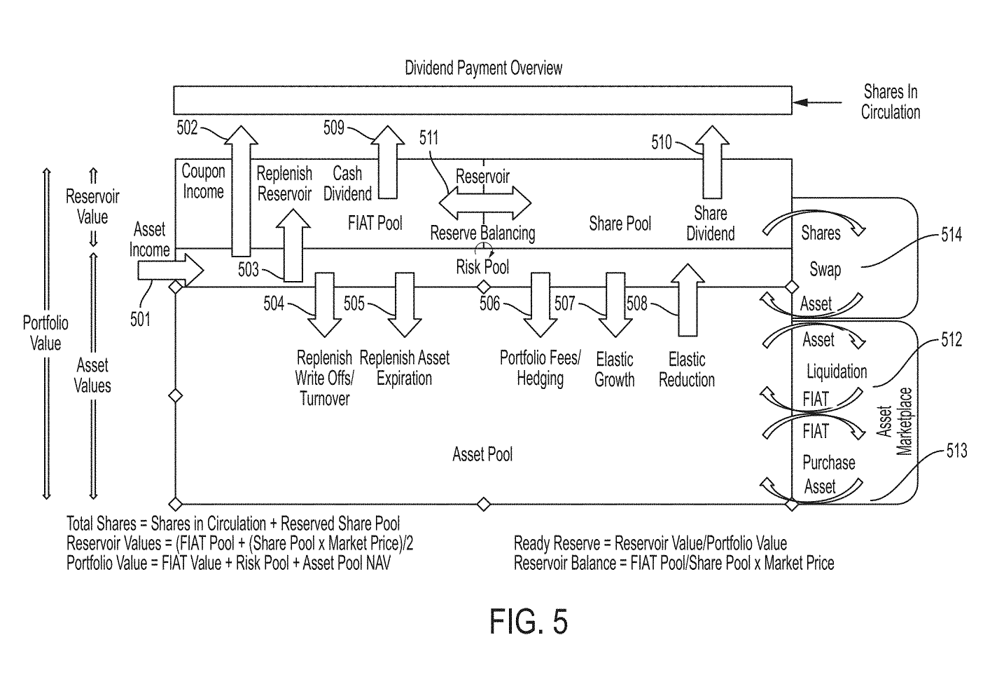

FIG. 5 illustrates the securitization model of the portfolio in detail. The securitization model includes three primary components. The asset pool, the risk pool and the reservoir. The asset pool is the value of the underlying assets such as the rights to rental or mortgage incomes. The risk pool is liquid assets, such as cash, that can be used to replenish the asset pool in the event of a default on an asset in the asset pool, for example when a loan in the asset pool has defaulted and been written off. The reservoir is a pool of liquid assets that can be used to restore liquidity in the Reservoir if reservoir cash levels are low based on an exodus of shareholders, as described in greater detail below. The reservoir includes a share of fiat money or other liquid assets and a pool of unowned shares in the portfolio.

As shown at 501, income from assets in the asset pool, e.g., realized earning potential, results in a reduction of the residual value of the asset pool (expiration) while increasing cash in the risk pool. An asset income event typically increases the overall Risk Adjusted Net Present Value (RANPV) of the portfolio (increase in risk pool balance exceeds the reduction in RANPV of the asset pool) proportional to the income stream risk. To maintain a constant par value of the asset pool, expiring earning potential should be replaced as described below.

As shown at 502, portfolio managers may offer coupon income to shareholders. This income can be paid preferentially before all other flows below. To ensure portfolio stability, this value should be less than the expected income from assets especially in the case of asset income volatility or uncertainty. Many portfolios will not offer Coupon Income.

As shown at 503, cash in the risk pool is used to restore liquidity in the reservoir if reservoir cash levels are low based on an exodus of shareholders. The amount of reservoir liquidity to be restored in this step is determined algorithmically, a function of Reservoir Balance, Ready Reserve, and market conditions. If significant liquidity restoration is required, resources may be unavailable for 504, 505, and 506 below, resulting in a reduction of the par value of the portfolio, one way in which a portfolio may shrink elastically as described in 507 below. If income levels fall below the liquidation threshold, this triggers the asset liquidation step as shown at 512 and described below.

As shown at 505, assets may be written off (residual value deemed to be zero) in a given period. Write offs result from defaulted loans or underperforming assets. To maintain constant par value, write offs must be replenished in the portfolio. Sufficient balance should be maintained in the Risk Pool to support “at risk” income streams, i.e. overdue loans or underperforming assets that may default in upcoming periods.

Asset residual values (earning potential) are reduced as income is received from assets in the portfolio. For example, a payment on a mortgage that reduces the principal of the loan result in a reduction in the earning potential of the asset, its residual value. This value can be replenished in the portfolio to maintain a constant par value, as shown at 505. Replenished cash can be used to purchase new assets restoring portfolio earning potential. Portfolios consisting of rapidly expiring assets will see significant expiration in a given period. The higher the expiration percentage, the greater the elasticity of the portfolio.

Management fee, hedging fees and other fees associated with maintaining the portfolio are paid out of the asset pool and must be replenished, as shown at 506, to avoid a change in the par value of the asset pool. Conversely, asset income or investor demand exceeding expectations will result in a cash inflow to the asset pool, as shown at 507, expanding portfolio par value elastically. Additional cash in the asset pool is used by the portfolio manager to acquire additional assets (see 513 described below). Elastic portfolio growth is triggered automatically when the reserve balance exceeds the growth threshold. Ratios between dividend payments and portfolio growth are determined algorithmically and controlled by the Portfolio's Growth/Income ratio.

Liquidity needs may result in a net outflow, as shown at 508, of value from the asset pool resulting in a reduction in the par value of the asset pool. Asset Pool cash outflows to replenish balances in the Risk Pool to support liquidity needs in 2-6 resulting from portfolio underperformance result in a reduction of assets under management gracefully drawing down a portfolio manager's influence based on the performance of assets under his or her control. Elastic portfolio reduction occurs automatically as Reserve Balance falls below the Liquidity Threshold. While technically closed fund, the elastic fluctuation in par value based on investor demand and asset performance provides desirable characteristics of an open fund. This hybrid approach is unique in the market.

Non-coupon dividends may be paid as cash or shares, as shown at 509, based on published portfolio guidelines. When the portfolio reserve balance exceeds the growth threshold, a cash payment is made according to the portfolio's published growth/income ratio. Cash dividends are ordinarily paid to shareholders proportional to their share ownership. When reserve balances are exceeded, dividends may be paid as shares from the share pool, as shown at 510. This is not a dilution as no new shares are issued. Shares can be distributed proportional to share balances in the system. Paying dividends as shares introduces a natural liquidity into the system as income can be converted to shares to pay the dividend and recipients may choose to monetize dividends paid as shares. Both actions introduce trading volume increasing market liquidity augmenting the markets ability to establish fair value.

High frequency market making algorithms help maintain a specified balance between available cash and shares. Significant changes to the Reserve Balance may occur due to changes in investor confidence in the underlying portfolio or large market moves from investors seeking or providing liquidity for external reasons. The algorithms react to adjust the price of liquidity in the face of these changes to return the reservoir to balance. A significant increase in the demand for cash will result in a flex in placed bids to increase the price of liquidity. At the same time, the market depth is added on the ask book to attract capital to support the desire for liquidity. This is described in greater detail below. If the Reserve Balance falls below the liquidation threshold, actions can be triggered requiring portfolio managers to sell assets, as shown at 512, to restore portfolio liquidity requirements. These triggers may be enacted via smart contracts on a distributed ledger or through other business logic mechanisms.

In some portfolios, portfolio managers purchase assets using cash from the asset pool as shown at 513. Assets that expire are replaced with cash from income streams. RANPV assessments and hedging strategies are the principal responsibility of a portfolio manager as these decisions reflect overall portfolio alpha. In other portfolios, assets enter the portfolio via swaps, i.e. exchanges of income earning shares for rights to asset earning potential as shown at 514. Some portfolios may use both techniques to acquire assets. The use of a swap vice cash purchases are preferred as this introduces additional liquidity into the portfolio.

The applicant has discovered a mechanism to ensure shareholder liquidity through the creation of a “liquidity engine.” The engine is purposed to backstop natural market liquidity and drive efficient pricing in the wake of large market moves. The engine uses high frequency market making algorithms drawing on the resources in the portfolio reservoir. The engine is a market departure from conventional market making activities in that the liquidity pool is a component of the portfolio meaning that shareholders, rather than a third party benefit from its activities. Market makers typically benefit significantly from market volatility. By turning these benefits to the shareholders, the novel model and algorithms introduce a countercyclical force into the markets rewarding shareholders who do not liquidate in times of volatility. This countercyclical force is particularly important in markets, such as real estate, that are characterized by deep business cycles and systemic lack of liquidity.

Often, large portfolios will retain a cash pool to help manage market changes. The applicant's invention is a repeatable engine that manages this pool using high frequency market making designed to set the marginal cost of liquidity. Market depth, that is the amount of market price change for a given size market order, determines the amount of liquidity in a market. Market liquidity is created by investors who set orders to buy or sell a security at a given price. Markets may become shallow during times of uncertainty, in the face of a large market move, or if investors or unaware or not interested in a given instrument. Shallow markets are characterized by friction, meaning that takers will be forced to offer a significant discount to execute their order. If the market is shallow enough, no trade at any price will be available to takers looking to execute a large order. In a liquid market, takers may move in and out of positions very efficiently with little cost in crossing the spread.

Deep markets benefit shareholders as they can quickly monetize positions at or near market price cashing out on value without taking a deep discount for the liquidity they require. The embodied liquidity engine leverages the novel model described above and supplements market depth as a service to shareholders by placing orders into the market using available shares and cash in the reservoir. As these orders are taken, it signals a market demand for liquidity. As the demand for liquidity increases, the engine adjusts the marginal cost of liquidity by setting new orders into the market increasing the spread for large market moves. The action drives up the cost of assets in the reservoir, protecting future liquidity, while continuing to provide liquidity into the market. This periodic or continuous action provides shareholders maximum liquidity while discouraging irrational runs against the asset. The reservoir is refilled by income streams from assets in the portfolio or by shifting market conditions as investors purchase shares from the reservoir restoring long run liquidity of the portfolio.

Large market moves by shareholders that are not driven by market conditions but rather individual needs for liquidity can also impact trading efficiency. In the wake of a large move, the spread (difference between bid and ask price) may be large, affecting the ability of shareholders looking to make routine transactions to monetize or purchase shares. It is desirable to rapidly close this spread to restore “true” market price and enable the order book reform. The engine has a mechanism to react quickly to these large moves to crystalize the market around a new price that most accurately reflects the market value of the portfolio.

The liquidity engine enhances the investment characteristics of the portfolio through synthetic liquidity, i.e., market augmentation designed to maximize liquidity & efficiently find long run portfolio price. It provides liquidity to shareholders from the first day of trading and in the face of market uncertainty. It enables shareholders to monetize share value efficiently even if natural market conditions are shallow. The engine drives the marginal cost of liquidity discouraging irrational runs against the portfolio and rewarding shareholders who do not follow the crowd with higher yields. Additionally, the engine helps the market efficiently settle to an efficient representation of the true value of the portfolio eliminating the pricing difficulties that characterized the 2008 crisis.

The liquidity engine can be embodied in computer software executed on computer hardware to enhance asset liquidity & price stability via two high frequency market making algorithms leveraging shareholder owned pools of cash and shares in the reservoir. A “fast twitch” market making algorithm provides price stability by facilitating consensus market price in the wake of large market moves by sprinkling orders designed to provide pricing options and narrow the spread. A “slow twitch” algorithm is used to backstop liquidity by setting the marginal cost of liquidity based on the market demand for liquidity. The liquidity engine algorithms are is described in detail below.

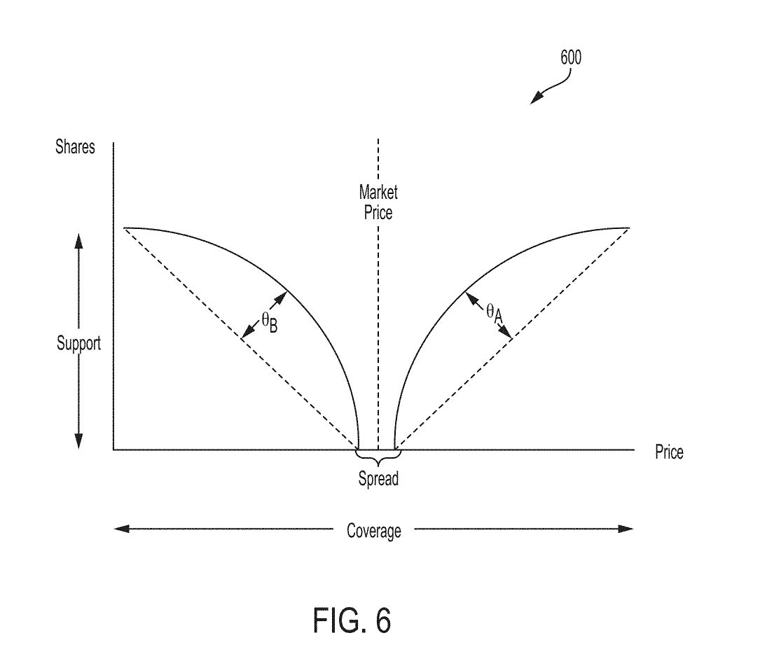

FIG. 6 identifies key targets used by the liquidity engine to augment an order book. In an order book, the market price is the mean of the highest bid and the lowest ask price for shares of an asset. This price is set by investor activity through the placement of limit and market orders. The liquidity engine observes trading history and the existing order book to determine a Target Market Price (TMP) for subsequent calculations to determine size and price of a series of limit orders designed to backstop market liquidity. TMP is determined algorithmically and is a function of trading price history, market volatility, the current order book, and the portfolio RANPV.

Market spread is the difference between the highest bid and the lowest ask price for shares of an asset. Spreads open in the wake of large market moves or investor uncertainty. The engine sets a Target Spread for subsequent calculations based on market volatility. The engine seeks to manage spread to minimize transaction friction for shareholders while settling price volatility.

Coverage is the price range used by the engine to place orders that backstop liquidity. The engine will place orders across the entire range of prices as defined by Coverage. Portfolio managers set engine Coverage is a function of shareholder liquidity needs, asset liquidity, and trading volatility.

Support is the total volume of shareholder moves covered at any given time by the liquidity engine. Shareholders desire Support to minimize friction for large share transactions in shallow markets. Support is a direct representation of share liquidity. Support is a function of available reservoir resources and Liquidity Decay as described below. FIG. 6 illustrates a market adjustment function of the liquidity engine of the disclosed embodiment. Order book 100 is represented as a graph of price versus share quantity. The marginal cost of liquidity is the change in Support for any given change in share price. If the marginal cost of liquidity is constant, share price to support an additional unit of volume will increase at a linear rate as shown by the dashed lines. Along this dashed line, the price of liquidity for shareholders remains constant. However, as noted above, the liquidity engine uses an algorithm in the form of f[(trading activity)(asset performance)(reservoir size)(reservoir balance)(portfolio settings)] to manage the marginal cost of liquidity by balancing shareholder need for liquidity immediately with the need to maintain a long run source of liquidity. The change in marginal cost of liquidity is represented by liquidity decay functions θ_{A} and θ_{B} to the ask side of the order book and the bid side of the order book respectively.

The liquidity decay functions set the marginal cost of liquidity by reshaping the natural market liquidity curves. In other words, the shape of the synthetic order book is adjusted as illustrated by the solid curves in FIG. 6. By shaping the reservoir's bid and ask order curves the engine backstops the price of market moves of different sizes providing a certain assured liquidity while increasing the cost of dramatic trades far from the consensus price. This behavior efficiently drives price to a new consensus as market conditions change. Decay on the bid (θ_{B}) and ask (θ_{A}) side of the order book are not necessarily the same as they are dependent on the balance of reserve cash and reserve shares respectively. The engine adjusts θ_{A} and θ_{B} to maintain a balance between the value of available shares and available cash. For example, as cash in drawn down in the reserve, the marginal cost of liquidity to exit the portfolio (monetization) will go up while the marginal cost of entering the portfolio (share purchase) will go down. Liquidity decay is a function of reservoir balances, the ratio of total reservoir value to portfolio RANPV, and a boost constant representing a liquidity incentive or disincentive set by the portfolio manager under shareholder oversight.

To illustrate the function of the liquidity engine, consider how it reacts in the case of a market run, a significant selloff of shares into an illiquid market. As shareholder begin to sell off shares, they are purchasing cash from the reservoir. In any instant, the larger the move, the greater the discount the shareholder must take according to synthetic market depth. These moves drive down market (and TMP). As cash resources in the reservoir begin to draw down, the marginal cost of liquidity goes up reshaping the synthetic order book to increase the cost of cash in the reservoir (protecting liquidity) and decrease the cost to move in (restoring liquidity to the reservoir) all the while providing a made market providing baseline liquidity for shareholders. Each cash move out of the reservoir results in a share move into the reservoir. These shares represent increased ownership of the portfolio income streams for existing shareholders. If the share pool remains in positive balance at the next dividend period, these shares are distributed to shareholders. Since those requiring liquidity (those who cash out) must offer a discount in shares increasing as more liquidity is demanded, those who stay put are gaining increased ownership of future income streams at a rate that is proportional to the demand for liquidity. In this way, the liquidity engine provides a countercyclical market force.

The liquidity engine algorithms and corresponding adjustment of the order book data structures ensure that liquidity is always available as shares can always be monetized. Conversely, shareholders who have provided liquidity into the underlying asset pool by purchasing the rights to future income streams are rewarded for providing liquidity at a rate that increases the more the market demands liquidity. The liquidity engine augments the most important principles in finance: that value remain liquid and that liquidity has value.

Payment gateways are services that provide convenient interfaces for users to quickly send funds to another user. Examples include PayPal, Stripe, Coinbase, and others. Payment gateways provide convenience to users enabling them to utilize account balances to engage in Point of Sale (POS) transactions. The popularity of payment gateways has resulted in a worldwide proliferation of services with some gateways, such as Payoneer, focusing on payment systems for the world's unbanked. Payment gateways may include cross currency exchanges allowing users to transfer value worldwide. Often, gateways are securely linked to third party bank accounts, credit cards, etc and offer a convenient way of sending stored value on demand.

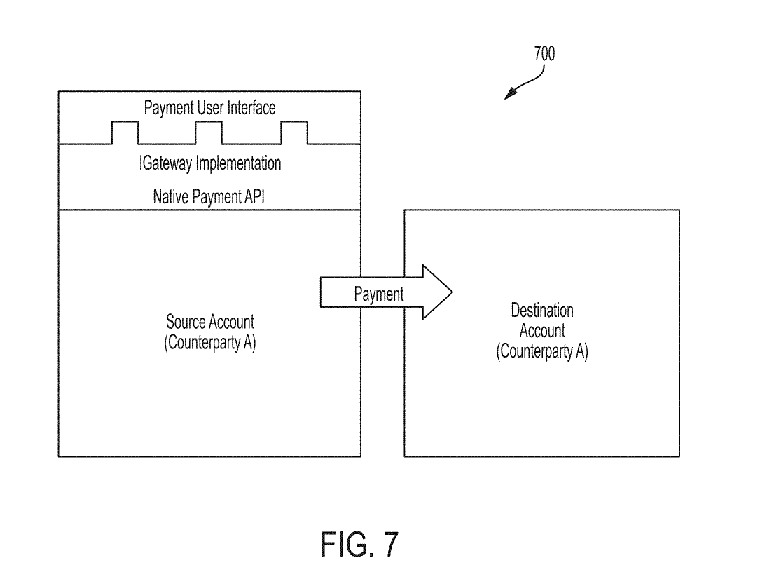

Most payment gateways provide an Application Programming Interface (API) that enables third party applications to make payments on behalf of their users. A simple flow payment is illustrated in FIG. 7. In step 701, a user requests to make a payment to a destination account through a user interface. This payment is received by the Gateway's native API. In step 702, value is transferred from the user's account (Source) to the recipient of the payment (Destination) account. This model is simple but has limitations. Tight coupling between the user interface and the native payment API limits user choice on the use of payment gateways. The user must have an established account with supported gateways to leverage the convenience of transactions via the user interface.

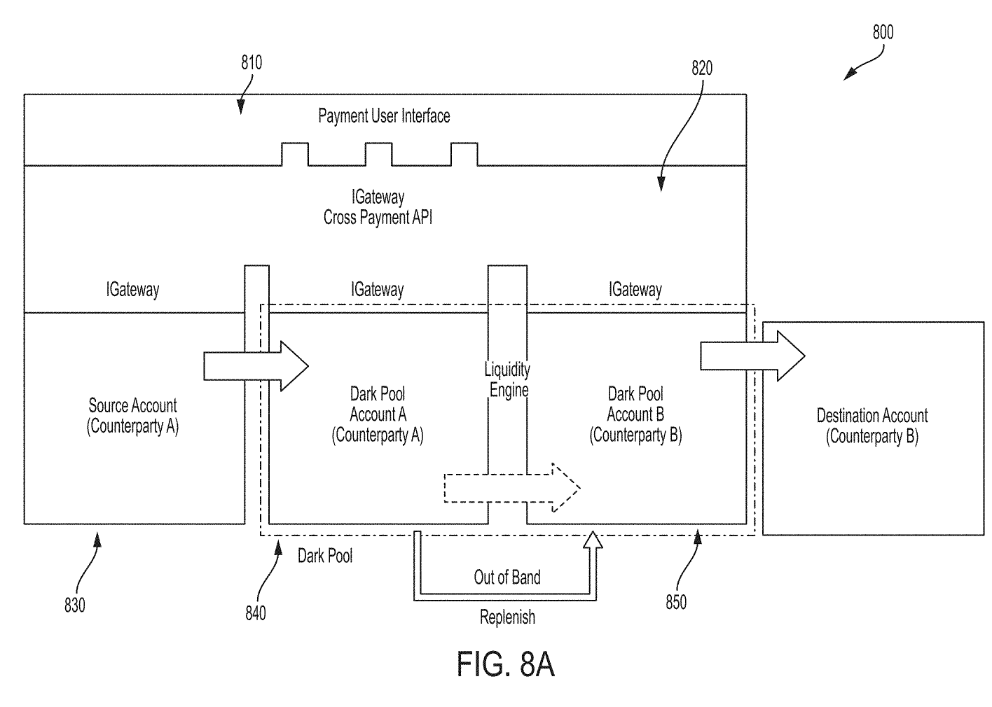

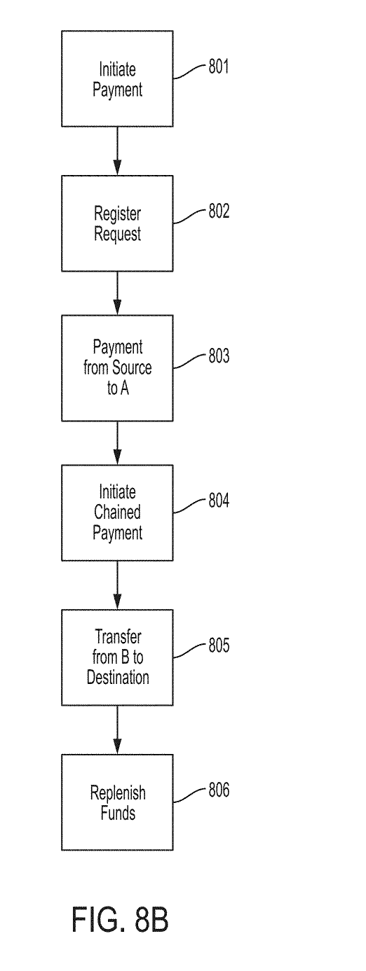

To address this limitation, the applicant has introduced a wrapper that includes a standardized software interface for making payments. This wrapper, shown as the IGateway interface in FIG. 8, provides a common mechanism to make a payment through any supported provider. This interface may be open sourced, enabling parties to quickly develop wrappers for native payment gateway APIs. This simplifies User Interface design as third parties may quickly enable support for Payment Gateways providers and may provide multiple options for users.

The architecture of FIG. 8A includes payment user interface 810, IGateway cross API 820, source account IGateway 830, dark pool A IGateway 840, and dark pool B IGateway 850.

More importantly, the recipient must also have an account with the payment gateway. With the proliferation of payment gateway providers and the need to exchange value worldwide, it is common to run into a scenario where a direct transfer is not possible. Since the applicant is driving to a goal of bringing liquidity to illiquid assets worldwide, a novel modular architecture and financial liquidity system has been invented. This architecture enables chaining of two or more payment gateways leveraging the modular architecture and dark pools of assets to ensure liquidity.

As illustrated in FIG. 8B, the user initiates a payment 801 to a recipient who uses a different payment gateway. The payment is initiated through a standard user interface that supports the IGateway interface. This request is registered 802 with a cross payment API service that manages successful implementation (cancellation or revocation) of the payment request as it is chained through gateways. The amount of source value required to deliver the desired amount to the destination is determined by gateway fees and liquidity price as determined by the liquidity engine disclosed above.

The cross payment API leverages the IGateway interface for gateway A to initiate a payment from the source account to dark pool A at 803. This payment follows the exact syntax as a single gateway payment. Once the source payment is received by the dark pool A and validated via the cross payment API, the cross payment API, initiates a chained payment using the IGateway interface for gateway B at 804. Funds are transferred from dark pool B account to the destination account using the syntax of a single gateway payment at 805. Funds in the gateway B dark pool are replenished from the dark pool A using an out of band model 806. This maintains the liquidity in the system. The IGateway interface to dark pool account A supports a transaction rollback if a failure or cancellation occurs while transferring funds. Although this architecture and functionality have many applications outside the transfer of value stored in digital currencies, they are effective to ensure that latent asset value stored in digital tokens can be translated to cash to support transactions worldwide.

The various functions disclosed herein can be accomplished by one or more computing devices having processors which execute instructions stored in one or more tangible computer readable memories. The various devices can be communicatively coupled to one another in known manners using known protocols. For example, the devices can be coupled over a Local Area Network or the Internet.

Additional alternative structural and functional designs may be implemented for securitizing assets and creating digital currency. Thus, while particular embodiments and applications have been illustrated and described, it is to be understood that the disclosed embodiments are not limited to the precise construction and components disclosed herein. Various modifications, changes and variations may be made in the arrangement, operation and details of the method and apparatus disclosed herein without departing from the spirit and scope of the invention defined in the appended claims.

What is claimed is:

1. A method executed by one or more computing devices for creating a portfolio representing asset earning potential that is represented by exchangeable digital tokens, the method comprising:
acquiring at least one derived asset representing rights to at least one revenue stream associated with underlying assets;
performing a risk adjusted present value evaluation function on at least one derived asset;
bundling at least one derived asset to create an asset pool with a PAR value;
issuing a predetermined number of shares against the pool of assets;
linking each share to a digital token;
issuing the digital tokens via a currency exchange; and
paying a dividend to token holders linked to income of the underlying assets.

2. The method of claim 1, further comprising:
enforcing asset owner obligations with at least one smart contract to decoupled earning potential and
limiting liquidity of swapped shares and recovering shares if obligations are not met.

3. The method of claim 1, further comprising:
establishing a reservoir of liquid assets associated within the portfolio with a purpose of managing liquidity, establishing fair market price, and enabling portfolio growth linked to asset performance and investor demand;
applying a liquidity algorithm whose beneficiary is the shareholders to the liquid assets in the reservoir adjust market pricing of the shares based on market conditions, outstanding shares, and reservoir asset value and portfolio value to thereby provide a countercyclical pricing model in response to systemic changes in market conditions and asset risk and performance; and
replenishing reservoir liquidity with income from assets in the portfolio providing a driver for liquidity as a function of time.

4. The method of claim 3, wherein the reservoir includes a fiat currency pool and share pool and further comprising a risk pool of liquid assets.

5. The method of claim 4, wherein replenishing reservoir liquidity with income from assets in the portfolio comprises transferring the income from the risk pool to the reservoir to meet preset liquidity requirements.

6. The method of claim 4, further comprising reducing or increasing the value of the asset pool through transfer to and from the risk pool based on realized income through preset rules maintained in a smart contract.

7. The method of claim 4, further comprising paying coupon income to shareholders out of the risk pool.

8. The method of claim 4, further comprising transferring value from the risk pool to the reservoir in response to reservoir value being reduced by a predetermined amount due to shareholders exiting the portfolio.

9. The method of claim 4, further comprising paying cash dividends to shareholders.

10. The method of claim 4, further comprising enabling portfolio PAR value to expand or contract elastically without share dilution, intermediaries such as a Authorized Participant, or a Level 3 pricing function according to the amount and balance of assets in the reservoir, market demand, and predetermined settings continuously enforced through a smaert contract.

11. A system architecture of chained exchanges for connecting currency and asset exchanges, the architecture comprising:
a payment user interface module;
an IGateway cross payment API module;
a first IGateway module associated with a source account;
a second IGateway module associated a dark pool A account; and
a third IGateway module associated with a dark pool B account;
wherein the IGateway cross payment module is operatively coupled to the first IGatwey module, the second IGateway module and the third IGateway module and wherein a path is through available exchanges is selected by the IGateway cross platform API module.

12. A method of transferring value between a source account and a destination account, the method comprising:
initiating a payment from the source account to dark pool A through an IGateway cross payment API and an IGateway interface associated with the source account;
receiving the payment through the IGateway cross payment API and an IGateway interface associated with a dark pool A associated with a counterparty;
initiating a chained payment through and IGateway interface associated with a dark pool B associated with a counterparty. transferring value from dark pool B to a destination account using the syntax of a single gateway payment; and
replenishing funds in dark pool B from the dark pool A using an out of band model.

13. The method of claim 1, wherein shares of the asset portfolio are backed by assets in the portfolio to thereby enable shareholders to redeem shares for individual assets in the portfolio for a market price and increase underlying assets liquidity and portfolio liquidity.

14. The method of claim 1, wherein all transactions related to the portfolio are recorded in a blockchain ledger thereby allowing access to transaction data by shareholders and portfolio management platforms through a common reporting interface.
